(19) United States
(12) Patent Application Publication
(10) Pub. No.: US 2015/0333565 A1
(43) Pub. Date: Nov. 19, 2015

(54) PHOTOVOLTAIC SYSTEM AND SOLAR PORT

(71) Applicant: General Electric Company, Schenectady, NY (US)

(72) Inventor: Charles Steven Korman, Niskayuna, NY (US)

(73) Assignee: General Electric Company, Schenectady, NY (US)

(21) Appl. No.: 14/279,803

(22) Filed: May 16, 2014

(51) Int. Cl. H02J 7/35; H02J 7/00; H02J 7/34; H02S 20/10; B60L 11/18

(52) U.S. Cl. CPC H02J 7/35; H02S 20/10; B60L 11/1811; H02J 7/345; H02J 7/0027

(57) ABSTRACT

Photovoltaic systems are presented. The photovoltaic system includes an array including a plurality of photovoltaic modules. At least one photovoltaic module in the array is movably coupled with an adjacent photovoltaic module and the array is configured to be slidably mounted on a plurality of support structures. A solar port is also presented.

### BACKGROUND

Embodiments of the invention relate generally to a photovoltaic system. More particularly, the embodiments of the invention relate to a photovoltaic system including an array of photovoltaic modules configured to be slidably mounted on a plurality of support structures. Presently available photovoltaic systems, and more particularly solar car ports, are expected to represent a substantial portion of a growing market for commercial solar systems. One of the challenges regarding implementation of such photovoltaic systems may be the cost. In particular, the solar car ports may be cost-prohibitive in some instances due to one or more of size requirements, weight of the various constituents, installation time, and installation cost.

Therefore, there exists a need for easily installable and cost-effective photovoltaic systems. Further, there exists a need for easily installable and cost-effective solar car ports.

### BRIEF DESCRIPTION

One embodiment of the invention is directed to a photovoltaic system. The photovoltaic system includes an array including a plurality of photovoltaic modules. At least one photovoltaic module in the array is movably coupled with an adjacent photovoltaic module, and the array is configured to be slidably mounted on a plurality of support structures.

Another embodiment of the invention is directed to a photovoltaic system. The photovoltaic system includes an array including a plurality of photovoltaic modules and a plurality of support structures. At least one photovoltaic module in the array is movably coupled with an adjacent photovoltaic module. Further, the plurality of support structures includes grooves and the array is slidably mounted into the grooves.

Yet another embodiment of the invention is directed to a solar vehicle port. The solar vehicle port includes an array including a plurality of photovoltaic modules, a plurality of support structures, an energy storage device, and an output unit. At least one photovoltaic module in the array is movably coupled with an adjacent photovoltaic module in the array. Further, the plurality of support structures includes grooves and the array is slidably mounted into the grooves. The energy storage device is electrically coupled to the array for storing electricity generated by the array. The output unit is electrically coupled to the energy storage device, and configured to supply the electricity to one or more vehicles.

### DRAWINGS

These and other features, aspects, and advantages of the present invention will become better understood when the following detailed description is read with reference to the accompanying drawings, in which like characters represent like parts throughout the drawings, wherein:

FIG. 1 illustrates a photovoltaic system, in accordance with one embodiment of the invention;

FIG. 2 illustrates a photovoltaic system, in accordance with one embodiment of the invention;

FIG. 3 illustrates a photovoltaic system, in accordance with one embodiment of the invention;

FIG. 4 illustrates an electrical connection of an array, in accordance with one embodiment of the invention;

FIG. 5A illustrates a locking arrangement for securing an array, in accordance with one embodiment of the invention;

FIG. 5B illustrates a locking arrangement for securing an array, in accordance with one embodiment of the invention;

FIG. 5C illustrates a locking arrangement for securing an array, in accordance with one embodiment of the invention;

FIG. 5D illustrates a locking arrangement for securing an array, in accordance with one embodiment of the invention; and

FIG. 6 illustrates a solar vehicle port, in accordance with one embodiment of the invention.

### DETAILED DESCRIPTION

The present disclosure may be best understood with reference to the figures and detailed description set forth herein. Various embodiments are discussed below with reference to the figures. However, those skilled in the art will readily appreciate that the detailed description given herein with respect to these figures is just for explanatory purposes as the system extends beyond the described embodiments.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. Here and throughout the specification and claims, range limitations may be combined and/or interchanged; such ranges are identified and include all the sub-ranges contained therein unless context or language indicates otherwise.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

Some embodiments of the invention are directed to a photovoltaic system. The photovoltaic system includes an array including a plurality of photovoltaic modules. At least one photovoltaic module in the array is movably coupled with an adjacent photovoltaic module, and the array is configured to be slidably mounted on a plurality of support structures.

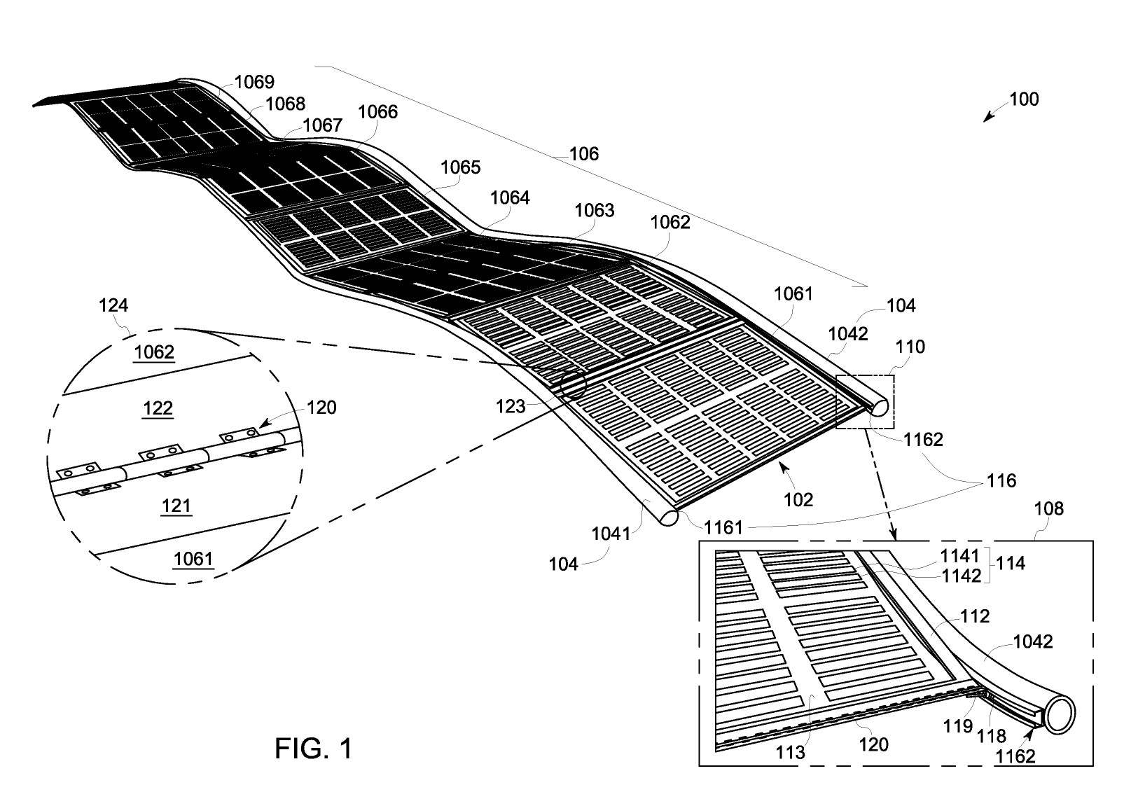

FIG. 1 illustrates a photovoltaic system 100, in accordance with one embodiment of the invention. The photovoltaic system 100 includes an array 102 and a plurality of support structures 1041 and 1042 (hereinafter collectively referred to as support structures 104) as shown in FIG. 1. The array 102 includes a plurality of photovoltaic modules 1061, 1062, 1063, 1064, 1065, 1066, 1067, 1068, and 1069 (hereinafter collectively referred to as photovoltaic modules 106). At least one photovoltaic module in the array 102 is movably coupled with an adjacent photovoltaic module. The array 102 may be configured to be slidably mounted onto the support structures 104.

Although the array 102 in FIG. 1 illustrates nine photovoltaic modules, the number of the photovoltaic modules in the array 102 may vary. The array 102 may include, for example, greater or lesser number of photovoltaic modules than the embodiment depicted in FIG. 1. In some embodiments of the invention, the number of the photovoltaic modules may be determined based on one or both of a required length of the array 102 and the dimensions of the photovoltaic modules 106 used.

For the sake of illustration and brevity, configuration of the photovoltaic modules 106 has been described with respect to the photovoltaic module 1061, herein below. Other photovoltaic modules (1062-1069) may have a configuration similar to that of the photovoltaic module 1061.

In some embodiments of the invention, as depicted in an enlarged view 108 of a portion 110 of the photovoltaic system 100, the photovoltaic module 1061 includes a frame 112 configured to mount a panel 113. The panel 113, as shown in FIG. 1, includes a plurality of solar cell units 114, such as, solar cell units 1141 and 1142. It should be noted that in FIG. 1, only two solar cell units 1141 and 1142 have been marked for the sake of representation and brevity. Although, the solar cell units 114 are shown to have a rectangular shape, the shape of the solar cell units 114 may be different including, but not limited to, square, circular, or elliptical.

In some embodiments of the invention, each solar cell unit, such as, the solar cell unit 1141 may include a plurality of solar cells. Each solar cell of the plurality of solar cells may include a photovoltaic cell that converts energy of the light into electricity by the photovoltaic effect. In some embodiments, the plurality of solar cells is connected in series.

The frame 112 may provide structural rigidity to the panel 113. In some embodiments of the invention, the frame 112 may include a metal, such as, aluminum. In other embodiments of the invention, the frame 112 may include any other suitable lightweight material. Use of aluminum or other lightweight material may result in reduction of the overall weight of the array 102. The reduced weight of the array 102 may also result in an overall lower cost of the photovoltaic system 100. In some embodiments of the invention, as opposed to traditional solar cell panels, a glass laminate may not be employed in the panel 113, thereby reducing overall weight of the array 102. For example, the overall weight of the array 102 without the glass laminate may be reduced to one third of the weight of a conventional array that employs traditional solar cell panels with glass laminate. Further, in some embodiments of the invention, the configuration of the panel 113 may be similar to a photovoltaic panel as described in the U.S. patent application Ser. No. 14/140,029, titled, ‘DEPLOYABLE SOLAR PANEL SYSTEM’, and assigned to GENERAL ELECTRIC COMPANY.

As noted earlier, the adjacent photovoltaic modules in the array 102 are movably coupled with each other. The terms “movably coupled” and “movable coupling” as used herein refer to any mechanical relationship between two elements (for example, adjacent photovoltaic modules) that allows one the two elements to move relative to other element. In some embodiments of the invention, the movable coupling of the photovoltaic modules 106 may include a hinge 120 or other suitable coupling mechanisms.

For example, one such movable coupling is illustrated in an enlarged view 124 of a potion 123 of the array 102. The adjacent photovoltaic modules 1061 and 1062 are coupled to each other via the hinge 120. In some embodiments of the invention, the hinge 120 may include a first component 121 and a second component 122. As depicted, the first component 121 may be coupled to the photovoltaic module 1061 and the second component 122 may be coupled to the photovoltaic module 1062 such that the photovoltaic modules 1061 and 1062 may be movable relative to each other. Although the enlarged view 124 depicts the hinge 120 of a continuous/piano type, other type of hinges such as a butt hinge, a butterfly hinge, a flush hinge, a barrel hinge, a concealed hinge, or combinations thereof may also be used. Although the hinge 120 is shown to be externally coupled to the photovoltaic modules 1061 and 1062 in the embodiment depicted in FIG. 1, in some alternative embodiments, the hinge 120 may be formed integral to the frame 112.

In some embodiments of the invention, the plurality of photovoltaic modules 106 may be pre-hinged, that is, adjacent photovoltaic modules are movably coupled using one or more hinges prior to being packaged for shipping. Pre-hinged photovoltaic modules 106 may reduce installation time while mounting the array 102 on the support structures 104. Further, the array 102 including the pre-hinged photovoltaic modules 106 may be folded in a compact form to facilitate shipping. Moreover, overall cost of installing the array 102 may also be reduced as the array 102 includes pre-hinged photovoltaic modules 106 that require reduced effort for coupling the photovoltaic modules at the time of installation.

In some embodiments of the invention, the photovoltaic modules 106 may be electrically connected in the array 102. The term “electrically connected” as used herein refers to any coupling of elements (for example, the photovoltaic modules 106) that allow a current to flow through one or more of the elements. In some embodiments of the invention, the photovoltaic modules 106 may be electrically pre-connected, that is, the photovoltaic modules 106 are electrically connected prior to being packaged for shipping. In some embodiments of the invention, the photovoltaic modules 106 may be connected in a series configuration. In other embodiments of the invention, the photovoltaic modules 106 may be electrically connected in other types of network configurations including, but not limited to, parallel configuration, or combination of the series and parallel configurations. In some embodiments of the invention, electrically pre-connecting the photovoltaic modules 106 may reduce the effort needed to electrically connect the photovoltaic modules 106 at the time of installation, thereby reducing the overall installation cost.

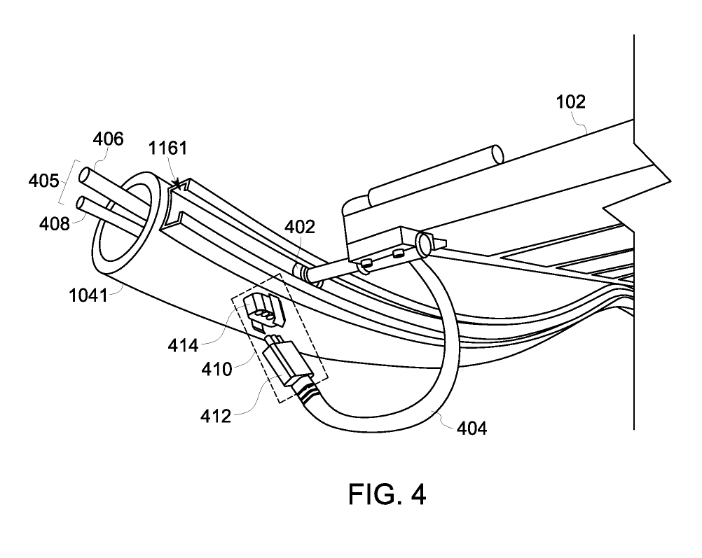

The support structures 104 may be substantially parallel, as shown in FIG. 1. The term “substantially parallel” as used herein refers to a configuration of elements (for example, the support structures 104) in which the distance between the two elements may vary by less than 5% across the length of the two elements. For example, when the distance between the support structures 1041 and 1042 across their length is constant, the elements are parallel to each other. In some embodiments of the invention, each of the support structures 104 may include a groove that may extend along the length of the support structures 104. The term “groove” as used herein refers to a structural provision on the support structures that aids in a slidable mounting (discussed later in the detailed description) of the array 102. For example, the support structure 1041 may include a groove 1161 (as shown in FIG. 4) that extends along the length of the support structure 1041. Similarly, the support structure 1042 may include a groove 1162 (as shown in the enlarged view 108 in FIG. 1) that extends along the length of the support structure 1042. Hereinafter, the grooves 1161 and 1162 are collectively referred to as the grooves 116. The grooves 1161 and 1162 may facilitate mounting of the array 102 onto the support structures 1041 and 1042, respectively.

In some embodiments of the invention, the support structures 104 may be manufactured from galvanized steel using roll forming, extrusion molding, or other commonly used processes. Other suitable materials may also be used to form the support structures 104 without limiting the scope of the present description. In one embodiment of the invention, the grooves 1161 and 1162 may be formed by appropriately machining the corresponding support structures 1041 and 1042. In another embodiment of the invention, the grooves 1161 and 1162 may also be formed simultaneously while manufacturing the support structures 1041 and 1042, respectively. In yet another embodiment of the invention, each of the grooves 1161 and 1162 may be a track like structure that may be attached to the corresponding support structure. For example, the groove 1162 (in this case, a separately formed track like structure) may be welded to the support structure 1042. Other attachment techniques, including use of various adhesives, are also contemplated herein.

The array 102 is configured to be slidably mounted onto the support structures 104. The term “slidably mounted” as used herein may correspond to mounting of the array 102 by sliding the array 102 onto the support structures 104. In some embodiments of the invention, the array 102 may further include one or more rolling elements. The rolling elements may facilitate easy mounting of the array 102 into the grooves 1161 and 1162 present on the support structures 1041 and 1042, respectively. In one embodiment of the invention, one or more of the photovoltaic modules 106 may include one or more rolling elements. In another embodiment of the invention, the first photovoltaic module (e.g., the photovoltaic module 1061) and/or the terminal photovoltaic module (e.g., photovoltaic module 1069) in the array 102 may include one or more rolling elements.

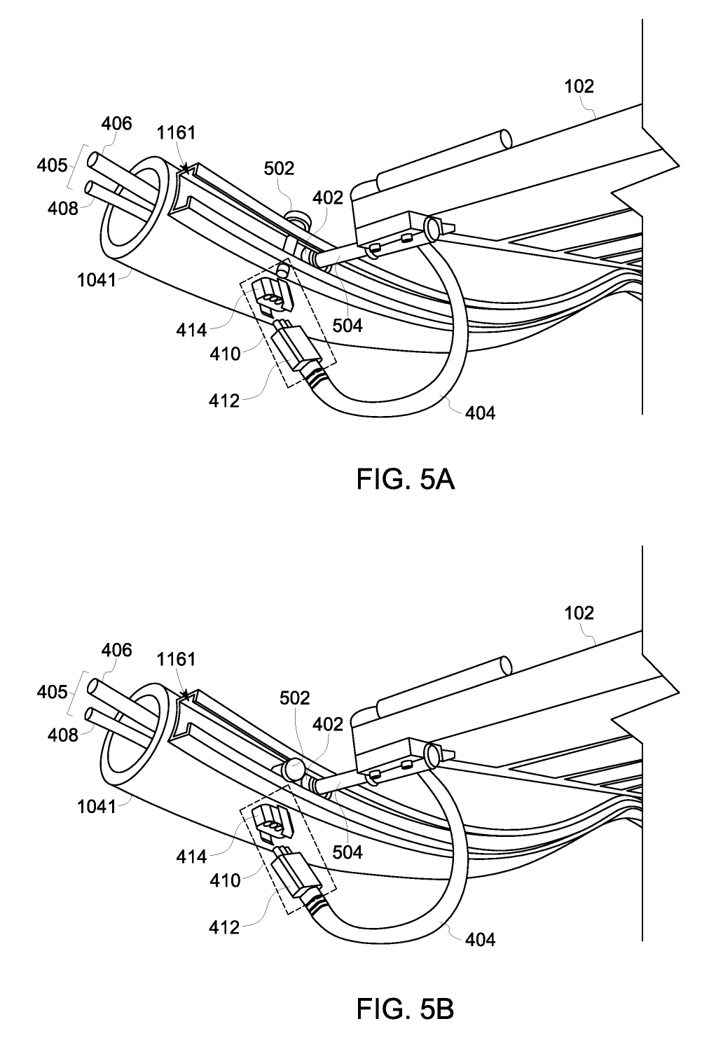

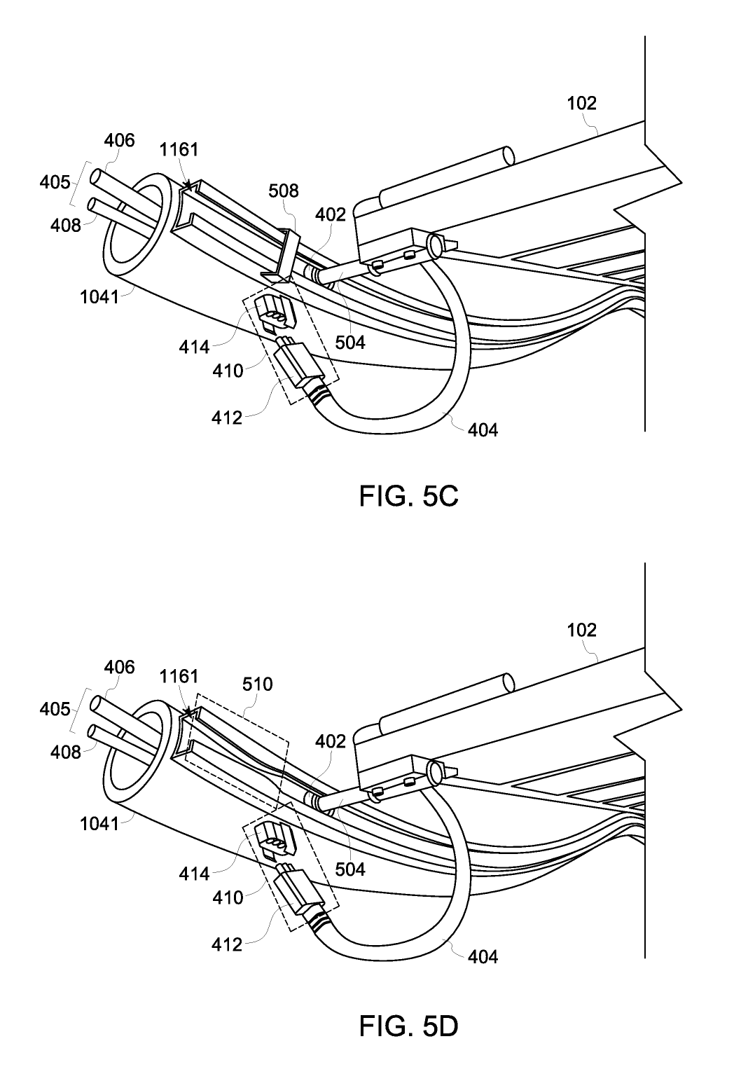

The enlarged view 108 in FIG. 1 illustrates one such rolling element 118 attached at one end of the photovoltaic module 1061 via a rod 119. One end of the rod 119 may be coupled to the frame 112 or the hinge 120 and other end of the rod 119 may be coupled to the rolling element 118 inside the groove 1162. FIG. 1 illustrates an embodiment with only one pair of rolling element 118 and rod 119. FIGS. 5A-5D illustrate embodiments including a plurality of pairs of rod and rolling element that facilitate sliding of the array 102 in the groove 1161. Non-limiting examples of the rolling element 118 include a roller, a bearing, or combinations thereof. In some embodiments of the invention, the rolling element 118 includes a roller. The roller may be of a cylindrical shape. External surface of the roller may provide reduced friction engagement with the inner surface of the grooves 1161 and 1162. Further, the roller may be configured to roll inside the grooves 1161 and 1162 and facilitate the movement of the array 102 into the grooves 1161 and 1162. In some embodiments of the invention, the external surface of the roller may also be suitably lubricated to facilitate mounting of the array 102. In some other embodiments of the invention, the rolling element 118 includes a bearing. Non-limiting examples of suitable bearings include, but are not limited to, a ball bearing, a roller bearing, a fluid bearing, a magnetic bearing, or combinations thereof.

In one embodiment of the invention, the rolling element 118 may be coupled to the hinge 120 via the rod 119. In another embodiment of the invention, the rod 119 may be formed as an integral part of the hinge 120 and the rolling element 118 may be coupled to the rod 119. In another embodiment of the invention, the rod 119 may be formed as an integral part of the frame 112 and the rolling element 118 may be coupled to the rod 119. In an alternate embodiment of the invention, the rod 119 may extend in to the groove 1162 and facilitate mounting of the array 102 on the support structures 1042 without the rolling element 118. In such an instance where rolling element 118 may not employed, an inner surface of the grooves 1161 and 1162 and/or an outer surface of the rod 119 may be suitably lubricated to facilitate easy sliding of the array 102 into the grooves 1161 and 1162.

During installation of the photovoltaic system 100, the array 102 including pre-hinged and electrically pre-connected photovoltaic modules 1061-1069, may be inserted from the first end 126 or the second end 128 of the support structures 104. For instance, the array 102 may be inserted from the first end 126 into the grooves 1161 and 1162 of the support structures 1041 and 1042, respectively. The array 102 may then be forced to slide into the grooves 1161 and 1162 thereby advancing to the second end 128. In this manner, the array 102 follows the trajectory defined by the support structures 104. In a non-limiting example, as depicted in FIG. 1, the photovoltaic system 100 may form a wave pattern defined by the support structures 104. In some embodiments of the invention, the photovoltaic system 100 may be configured to have different shapes including, but not limited to, a straight shape or a curved shape, without limiting the scope of the present specification.

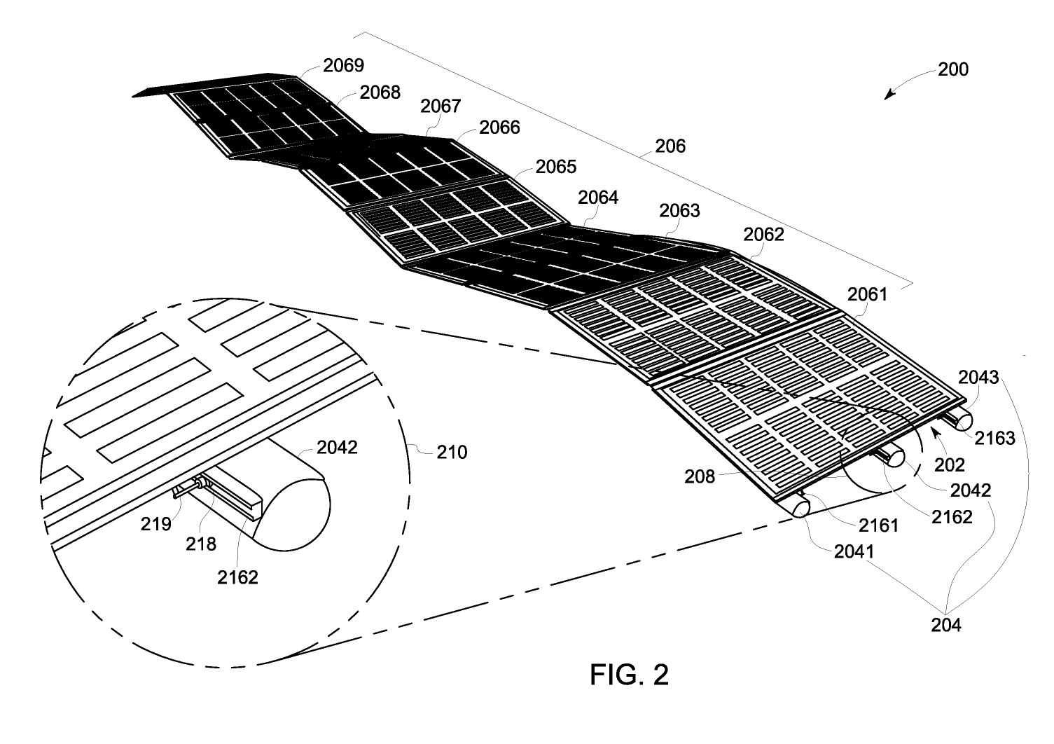

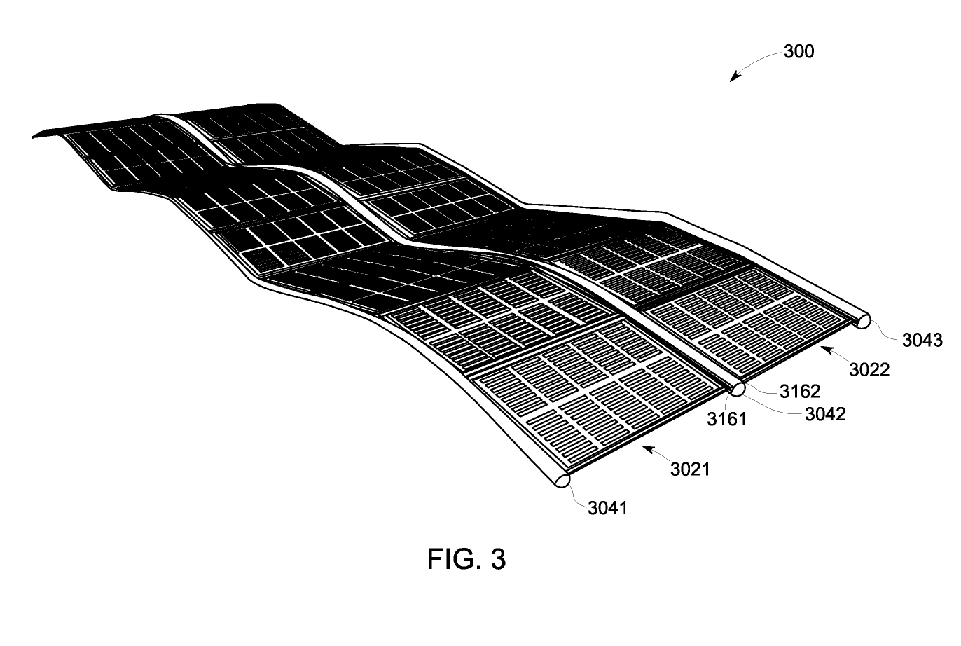

Although only two support structures such as the support structures 1041 and 1042 have been depicted in FIG. 1, greater number of support structures may also be employed (See FIG. 2). For example, FIG. 3 illustrates an embodiment including three support structures.

Referring now to FIG. 2, a photovoltaic system 200, in accordance with one embodiment is illustrated. The photovoltaic system 200 includes an array 202. The photovoltaic system 200 also includes a plurality of (for example, three) support structures such as support structures 2041, 2042, and 2043. The support structures 2041, 2042, and 2043 are hereinafter also collectively referred to as support structures 204. The support structures 2041, 2042, and 2043 may include grooves 2161 (not visible), 2162, and 2163, respectively. The grooves 2161, 2162, and 2163 may extend along the length of the support structures 2041, 2042, and 2043, respectively. As noted with respect to FIG. 1, the grooves 2161, 2162, and 2163 facilitate mounting of the array 202 on the support structures 2041, 2042, and 2043, respectively.

In the embodiment depicted in FIG. 2, the support structure 2042 includes a groove 2162. However, in some alternate embodiments of the invention, the support structure 2042 may not include the groove, and may be configured provide mechanical support to the array 202.

In FIG. 2, the array 202 includes a plurality of photovoltaic modules 2061, 2062, 2063, 2064, 2065, 2067, 2068, and 2069. The plurality of photovoltaic modules 2061-2069 are hereinafter collectively referred to as photovoltaic modules 206. The configuration of the array 202 is similar to that of the array 102, except with an addition of a rod 219 and a rolling element 218. The rolling element 218, as depicted in greater detail in an enlarged view 210 of a portion 208, facilitates sliding of the array 202 in the groove 2162.

Such configurations, where more than two support structures are employed, may provide improved support to the array of photovoltaic modules. Such configurations may be used when the width of the array is substantially large to provide structural support at intermediate positions.

FIG. 3 illustrates a photovoltaic system 300, in accordance with one embodiment of the invention. The photovoltaic system 300 includes a plurality of arrays of photovoltaic modules, such as, arrays 3021 and 3022. The photovoltaic system 300 further includes three support structures such as support structures 3041, 3042, and 3043. As depicted in FIG. 3, the array 3021 is slidably mounted on the support structures 3041 and 3042; and the array 3022 is slidably mounted on the support structures 3042 and 3043. In such a configuration, the support structure 3042 includes two grooves, such as, grooves 3161 and 3162 (not visible). The groove 3161 facilitates mounting of the array 3021 and the groove 3162 facilitates mounting of the array 3022. Since the arrays 3021 and 3022 are similar to the array 102 in various aspects, details of the arrays 3021 and 3022 have not been discussed for the sake of brevity. Similarly, since the support structures 3041 and 3043 are similar to the support structures 1041 and 1042 respectively in various aspects, details of the support structures 3041 and 3043 have not been discussed for the sake of brevity.

FIG. 4 illustrates an electrical connection for an array 102, in accordance with one embodiment of the invention. FIG. 4 depicts a plug and play architecture where the array 102 includes the electrically pre-connected photovoltaic modules 106. As depicted in FIG. 4, the array 102 is configured to move along the groove 1161 via the rolling element 402. Also, as noted earlier, the photovoltaic modules 106 are electrically pre-connected. A direct current (DC) bus 405 including a first conducting wire 406 and a second conducting wire 408 may be disposed within the support structure 1041. Alternatively, the DC bus 405 may also be disposed in other support structures, such as, the support structure 1042 without limiting the scope of the present specification. The DC bus 405 allows the flow of a DC current generated by the array 102. In one embodiment of the invention, the first conducting wire 406 may be a power line, and a second conducting wire 408 may be a neutral line from the array 102. In some embodiments of the invention, the DC bus 405 may also include a ground wire. In some other embodiments, any of the support structures 104 may be configured as a ground medium for the electricity generated by the array 102.

In some embodiments of the invention, a bus 404 may allow transfer of electricity generated by the array 102 to an electrical connector 410. The bus 404 may include a power wire and a neutral wire. The electrical connector 410 may have two parts—a female socket 414 and a male connector 412. In some embodiments of the invention, when the DC bus 405 includes the ground wire, the electrical connector 410 may also be configured to include a corresponding ground pin. The female socket 414 may be electrically coupled to the DC bus 405. The array 102 may be electrically coupled to the DC bus 405 via an electrical connector 410 when the female socket 414 and the male connector 412 are coupled. When the female socket 414 and the male connector 412 are coupled, the power wire of the bus 404 is coupled to the power line of the DC bus 405 and the neutral wire of the bus 404 is connected to the neutral line of the DC bus 405. In one embodiment of the invention, the female socket 414 may be fixed to a support structure that carries the DC bus 405. In FIG. 4, the female socket 414 is shown as being fixed to the support structure 1041 near the second end 128. In another embodiment of the invention, the female socket 414 may be fixed to the support structure 1041 near the first end 126.

FIGS. 5A, 5B, 5C, and 5D illustrate various locking arrangements for securing the array 102, in accordance with some embodiments of the invention. FIGS. 5A and 5B illustrate locking arrangements including a locking element 502. As depicted in FIG. 5A, the locking element 502 is inserted through the groove 1161. Alternatively, as depicted in FIG. 5B, the locking element 502 may be inserted substantially parallel to the rod 504 into the support structure 1041. The insertion of the locking element 502 may restrict forward movement/sliding of the rolling element 402 or a rod 504 (in case the rolling element is not used) thereby securing the array 102 on the support structures 1041 and 1042. Examples of the locking element 502 include but are not limited to a pin, a screw, a bolt, a fastener, a nut and bolt assembly, and the like. In one embodiment of the invention, holes for inserting the locking element 502 may be pre-drilled on the groove 1161. In another embodiment of the invention, the holes may be drilled at the time of installing the photovoltaic system 100. FIG. 5C illustrates another locking arrangement including a locking element 508 such as a clamp attached to the groove 1161. The locking element 508 may restrict forward movement/sliding of the rolling element 402 or the rod 504 (in case the rolling element is not used) thereby securing the array 102 on the support structures 1041 and 1042.

Although one locking element has been shown in the configurations described in each of FIGS. 5A, 5B, and 5C, the locking elements may also be provided at multiple locations on one or more of the support structures 104. In this instance, one or both of a placement and number of the locking elements may be selectively chosen in order to adjust a tilt angle of the array 102.

FIG. 5D illustrates another locking arrangement in which the groove 1161 may be shaped such that forward movement/sliding of the rolling element 402 or the rod 504 (in case the rolling element is not used) may be restricted. For example, the groove 1161 may be bent or provided with additional material thickness in a region 510 such that further movement/sliding of the rolling element 402 or the rod 504 (in case the rolling element is not used) may be restricted, thereby securing the array 102 on the support structures 1041 and 1042. In other embodiments of the invention, a locking arrangement may be implemented by providing a closed end of the grooves 1161 and/or 1162. For example, if the array 102 has to be inserted in the grooves 1161 and 1162 from the first end 126, the grooves 1161 and/or 1162 may be closed at the second end 128, and vice versa.

Some embodiments of the invention are directed to a solar vehicle port. The solar vehicle port includes an array including a plurality of photovoltaic modules, a plurality of support structures, an energy storage device, and an output unit. At least one photovoltaic module in the array is movably coupled with an adjacent photovoltaic module in the array. Further, the plurality of support structures includes grooves and the array is slidably mounted into the grooves. The energy storage device is electrically coupled to the array for storing electricity generated by the array. The output unit is electrically coupled to the energy storage device, and configured to supply the electricity to one or more vehicles.

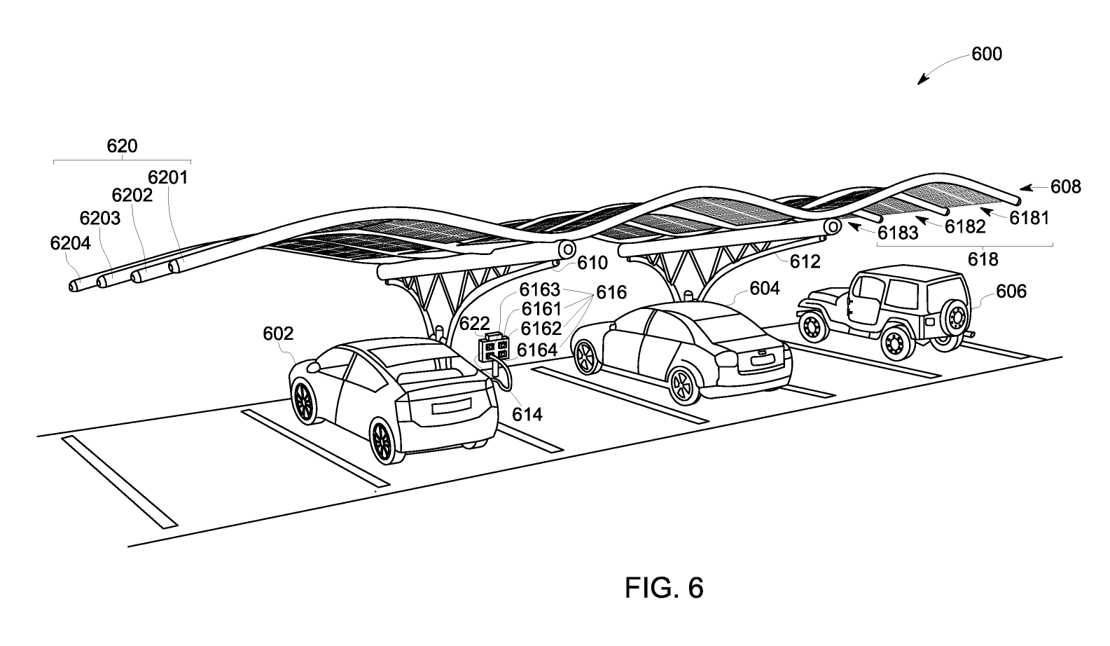

FIG. 6 illustrates a solar vehicle port 600, in accordance with one embodiment of the invention. The solar vehicle port 600 may provide a parking space, electric charging facility to one or more vehicles, such as, vehicles 602, 604, and 606. The solar vehicle port may also provide protection from rain, dust, direct sun light, and the like, to the vehicles 602, 604, and 606. As shown in FIG. 6, the solar vehicle port 600 includes a photovoltaic system 608, ground support structures 610 and 612, an energy storage device 614, and output units 6161, 6162, 6163, and 6164 (hereinafter collectively referred to as output units 616).

In the embodiment illustrated in FIG. 6, the photovoltaic system 608 includes an arrangement of three arrays 6181, 6182, and 6183 (hereinafter collectively referred to as arrays 618). As depicted, the arrays 618 are slidably mounted on a plurality of support structures 6201, 6202, 6203, and 6204 (hereinafter collectively referred to as support structures 620). Configuration of each of the arrays 618 may be similar to the configuration of the array 102. The configuration of the support structure 6201 may be similar to the configuration of the 1041, the configuration of the support structures 6202 and 6203 may be similar to the configuration of the support structure 2042, and the configuration of the support structure 6204 may be similar to the configuration of the support structure 1042.

As depicted in FIG. 6, the photovoltaic system 608 is mounted on the ground support structures 610 and 612. In one embodiment of the invention, the ground support structures 610 and 612 may cantilever the photovoltaic system 608 above the ground. Although, only two ground support structures have been shown, greater or fewer number of ground support structures may also be employed. Further, the height of the ground support structures 610 and 612 may be determined based on a maximum height of the vehicles that the solar vehicle port 600 is designed to support.

The energy storage device 614 may include a battery, a capacitor, or combinations thereof. The energy storage device 614 may be configured to store the electricity generated by the photovoltaic system 608. In one embodiment of the invention, the batteries or capacitors may be connected in series to increase the overall energy storage. Further, the solar vehicle port 600 may also include suitable electronic circuits (not shown) to facilitate charging of the energy storage device 614.

In some embodiments of the invention, an inverter unit 622 may also be connected to the energy storage device 614. The inverter unit 622 converts DC voltage from the energy storage device 614 to an Alternating Current (AC) voltage. The inverter unit 622 may be implemented by using any suitable inverter.

In one embodiment of the invention, the output units 616, as shown in FIG. 6, may be coupled to the energy storage device 614. Each of the output units 616 may supply the electricity (e.g., DC current) from the energy storage device 614 to any vehicle that is connected for electrical charging. In another embodiment of the invention, the output units 616 may be coupled to the energy storage device 614 via the inverter unit 622. In this case, the output units 616 may supply the electricity (e.g., AC current) from the inverter unit 622 to any vehicle that is connected for electrical charging. In yet another embodiment of the invention, some of the output units 616 may be directly coupled to the energy storage device 614 while rest of the output units 616 may be coupled to the energy storage device 614 via the inverter unit 622. In one embodiment of the invention, one or more of the output units 616 may be compliant with SAE standards, established by SAE International®. For example, the output units 616 may support Level 2 and/or DC fast charge. The Level 2 may support 240 volt AC charging. The DC fast charge support 500 volt DC high-current charging. In one embodiment of the invention, the output units 616 may support single-phase or three-phase charging.

The present invention has been described in terms of some specific embodiments. They are intended for illustration only, and should not be construed as being limiting in any way. Thus, it should be understood that modifications can be made thereto, which are within the scope of the invention and the appended claims.

It will be appreciated that variants of the above disclosed and other features and functions, or alternatives thereof, may be combined to create many other different systems or applications. Various unanticipated alternatives, modifications, variations, or improvements therein may be subsequently made by those skilled in the art and are also intended to be encompassed by the following claims.

1. A photovoltaic system, comprising:
an array comprising a plurality of photovoltaic modules, wherein at least one photovoltaic module in the array is movably coupled with an adjacent photovoltaic module;
and wherein the array is configured to be slidably mounted on a plurality of support structures.

2. The photovoltaic system of claim 1, wherein the array is configured to be slidably mounted into grooves present in the plurality of the support structures.

3. The photovoltaic system of claim 1, wherein the array further comprises at least one rolling element to facilitate mounting of the array on the plurality of support structures.

4. The photovoltaic system of claim 3, wherein the at least one rolling element comprises a roller, a bearing, or combinations thereof.

5. The photovoltaic system of claim 1, wherein the at least one photovoltaic module is movably coupled with the adjacent photovoltaic module via a hinge.

6. The photovoltaic system of claim 1, wherein the plurality of photovoltaic modules are electrically coupled with each other.

7. The photovoltaic system of claim 1, further comprising at least one locking element to secure the array at a predefined position on the plurality of support structures.

8. A photovoltaic system, comprising:
an array comprising a plurality of photovoltaic modules, wherein at least one photovoltaic module in the array is movably coupled with an adjacent photovoltaic module; and
a plurality of support structures comprising grooves, wherein the array is slidably mounted into the grooves.

9. The photovoltaic system of claim 8, wherein the plurality of support structures comprises a pair of substantially parallel support structures.

10. The photovoltaic system of claim 8, wherein the array further comprises at least one rolling element, and the array is mounted into the grooves via the at least one rolling element.

11. The photovoltaic system of claim 8, wherein the at least one photovoltaic module is movably coupled with the adjacent photovoltaic module via a hinge.

12. The photovoltaic system of claim 8, wherein at least one support structure in the plurality of support structures comprises an electrical wiring.

13. The photovoltaic system of claim 12, wherein the electrical wiring comprises a Direct Current (DC) bus configured to carry a DC current generated by the array.

14. The photovoltaic system of claim 8, wherein the array is mounted on the plurality of support structures such that the array follows a trajectory defined by the plurality of support structures.

15. A solar vehicle port, comprising:
an array comprising a plurality of photovoltaic modules, wherein at least one photovoltaic module in the array is movably coupled with an adjacent photovoltaic module;
a plurality of support structures comprising grooves, wherein the array is slidably mounted into the grooves;
an energy storage device electrically coupled to the array for storing electricity generated by the array; and
an output unit electrically coupled to the energy storage device, wherein the output unit is configured to supply the electricity to one or more vehicles.

16. The solar vehicle port of claim 15, further comprising an inverter unit, wherein the output unit is electrically coupled to the energy storage device via the inverter unit.

17. The solar vehicle port of claim 15, wherein the energy storage device comprises a battery, a capacitor, or combinations thereof.

18. The solar vehicle port of claim 15, wherein the array further comprises at least one rolling element, and the array is mounted into the grooves via the at least one rolling element.

19. The solar vehicle port of claim 18, wherein the at least one rolling element comprises a roller, a bearing, or combinations thereof.

20. The solar vehicle port of claim 15, wherein the at least one photovoltaic module is movably coupled with the adjacent photovoltaic module via a hinge.
